(19) United States
(12) Patent Application Publication
(10) Pub. No.: US 2005/0079435 A1
(43) Pub. Date: Apr. 14, 2005

(54) Process cartridge and image forming apparatus and method of manufacturing the same

(76) Inventor: Motoi Ebizuka, Nagano (JP)

Correspondence Address: RABIN & Berdo, PC, 1101 14TH STREET, NW, SUITE 500, WASHINGTON, DC, 20005, US

(21) Appl. No.: 10/934,745

(22) Filed: Sep. 7, 2004

(30) Foreign Application Priority Data
Oct. 9, 2003 (JP) JP PA2003-350277

(51) Int. Cl. G03G 15/00; G03G 21/18

(52) U.S. Cl. 430/127; 399/159; 399/111

(57) ABSTRACT

The invention provides a process cartridge and a high performance image forming apparatus in which no image defect such as image deletion, is caused by appropriately reducing the dispersion of a surface property between plural photoconductors used in the color image forming apparatus of a tandem system particularly at the early stage. Therefore, the process cartridge for the image forming apparatus of the tandem system has a photoconductor having at least a photosensitive layer on an electrically conductive substrate, and also has image forming apparatus for forming a toner image on the surface of the photoconductor. The electrically conductive substrate has a sandblast-processed outer surface. The image forming apparatus of the tandem system has plural photoconductors each having at least a photosensitive layer on an electrically conductive substrate, and also has apparatus for respectively forming toner images of plural colors on the surfaces of the photoconductors. The electrically conductive substrate surfaces of the plural photoconductors are all sandblast-processed.

### BACKGROUND OF THE INVENTION

1. Field of the Invention

The invention relates to a process cartridge and an image forming apparatus, and a method for its manufacture. More particularly, the invention relates to a process cartridge for an image forming apparatus for forming an electrostatic latent image corresponding to a recorded image on a photoconductor and obtaining the recording image by transferring a visible image visualized by developing this latent image by a developing agent to a transfer medium such as paper. The invention also relates to the image forming apparatus and a method of manufacturing method of manufacturing a process cartridge for the image forming apparatus.

2. Description of the Related Art

An image forming apparatus for forming an image is conventional and well-known. In the image forming apparatus, process means for exposure, development, transfer, cleaning (residual toner removal), electricity removal and charging are arranged around a photoconductor and the image is produced by performing this series of electrophotographic processes in order. The image forming apparatus, using such an electrophotographic system, adopts many structures using a process cartridge in which one portion or all of the photoconductor and the process means integrally form the cartridge and can be detachably attached to the apparatus main body.

A color image forming apparatus of a tandem system recently has been developed in response to a widening desire for and use of a color image forming apparatus. In this color image forming apparatus, the photoconductor and a developing device are arranged with respect to each of four colors so as to realize the formation of a color image at a high speed equal to that of the monochromatic image. The color image obtained by overlapping the images of the four colors can be formed on a sheet of paper as it makes in a single pass along one path.

FIG. 1 shows a schematic view of the construction of such an image forming apparatus of the tandem system. As shown in this figure, image forming sections including photoconductors 1a to 1d, chargers 11a to 11d, exposure devices 12a to 12d, developing devices 13a to 13d and transfer devices 14a to 14d with respect to the respective four colors of cyan (C), magenta (M), yellow (Y) and black (BK) are arranged in the image forming apparatus of this system. While an unillustrated transfer medium such as paper is conveyed by a conveying belt 20, the color images of the four colors can be formed in parallel with each other on the surface of the transfer medium. Therefore, the image forming apparatus is suitable to make the color record at high speed.

In such an image forming apparatus of the tandem color system, it is particularly necessary to make the surfaces of the four photoconductors uniform so as to obtain a preferable image. However, in reality, there are usually dispersions with respect to the surface property of the photoconductor, i.e., its smoothness, lightness, reflectivity, etc. between manufacture lots, and within the same manufacture lot. As a technique relating to an improvement of the surface property of a photoconductor, for example, Japanese Patent Publication JP-A-2002-296822 describes a technique relating to the photoconductor, and prescribes the state of a substrate side interface of a photosensitive layer by using a specific parameter to realize a high quality image. Further, a technique relating to sandblast processing with respect to the surface of a substrate of the photoconductor is described in Japanese Patent Publications JP-A-10-48863 and JP-A-2000-105481.

On the other hand, the image also can be monochromatically formed in the tandem color system. In such a case, the image forming process with respect to a color absent from the image is stopped. However, as shown in FIG. 1, the photoconductors la to Id come into light contact with the transfer medium such as a paper sheet. Accordingly, it is necessary to rotate the photoconductors 1a to 1d so as not to be damaged.

Moreover, even when all the image forming sections of the four colors are not used in the image forming apparatus of the tandem color system, a transfer bias for drawing the transfer medium to the conveying belt may be required. That is, in such a case, a transfer bias must be applied to the image forming section of the color absent from the image in a certain case if the first of the four image forming sections (first in the order of passing of the transfer medium) is for a color that is not present in the image to be printed.

Further, even when no image is formed, similarly to the case of the transfer bias, a load similar to that at the time of image formation is applied to the photoconductor when the same operations, e.g., rotation of the charger, high voltage application, etc. are performed when an image is formed. Therefore, wear on the photoconductor is increased with respect to the amount of toner consumed, and dispersion is caused with respect to the surface property between the four photoconductors, so that the life of the photoconductor is shortened.

When the dispersion of the surface property is increased between the four photoconductors in the above case, the colors are unbalanced and no densities of cyan, magenta, yellow and black become predetermined values. Therefore, a problem of image deletion is caused. With respect to this problem of image deletion, for example, Japanese Patent Publication JP-A-2000-214651 describes a technique relating to the image forming apparatus in which a rotatable charging means coming in contact with the photoconductor is arranged in the image forming section.

As mentioned above, with respect to the photoconductor used in the color image forming apparatus of the tandem system, it is required that the surfaces between the respective photoconductors are uniform and the dispersion is small with respect to surface properties such as roughness, lightness, reflectivity, etc. However, this point has not been sufficiently considered so far. Namely, the techniques described in Japanese Patent Publications JP-A-2002-296822, JP-A-10-48863 and JP-A-2000-105481 are improvements relating to the image quality of the individual photoconductors, and dissolution of the dispersion between the respective photoconductors is not an object of these techniques. Further, the technique described in Japanese Patent Publication JP-A-2000-214651 is for improving the image forming process in the image forming apparatus, and is not a technique relating to the improvement of the photoconductor itself.

### SUMMARY OF THE INVENTION

Therefore, an object of the invention is to provide a process cartridge and a high performance image forming apparatus, in which no image defect such as image deletion, is caused by appropriately reducing the dispersion of the surface properties between the plural photoconductors used in the color image forming apparatus of the tandem system, particularly at the early stage.

To solve the above problems, the present inventors have found as a result of earnest consideration that the dispersion of the surfaces between the respective photoconductors is reduced and the image forming apparatus and the process cartridge having the photoconductors with a predetermined desirable uniform surface property can be realized by sandblast-processing the surfaces of the photoconductors used in the image forming apparatus. Namely, the process cartridge of the invention is a process cartridge for an image forming apparatus of a tandem system that includes a photoconductor with at least a photosensitive layer on an electrically conductive substrate, and image forming means for forming a toner image on the surface of the photoconductor, wherein the electrically conductive substrate surface of the photoconductor is sandblast-processed.

A method according to the invention for manufacturing such a process cartridge of an image forming apparatus of a tandem system, includes providing a photoconductor having at least a photosensitive layer and an electrically conductive substrate. To obtain the cartridge, an electrically conductive substrate is provided, a surface of the substrate is sandblast-processed and at least the photosensitive layer is provided on the sandblast-processed substrate surface.

Further, according to another aspect of the invention, there is provided an image forming apparatus of a tandem system that includes plural photoconductors, each having at least a photosensitive layer on an electrically conductive substrate, and plural image forming means for respectively forming toner images of plural colors on the surfaces of the photoconductors, wherein the electrically conductive substrate surfaces of the photoconductors are sandblast-processed. According to still further aspect of the invention, there is provided an image forming apparatus of a tandem system that includes photoconductors each having at least a photosensitive layer on an electrically conductive substrate for four colors, namely cyan, magenta, yellow and black, and image forming means of the four colors for respectively forming toner images on the surfaces of the photoconductors, wherein the electrically conductive substrate surfaces of the respective photoconductors are sandblast-processed.

The invention is more effective in an image forming apparatus and a process cartridge having a high resolution of 1200 dpi or more, especially, 2400 dpi or more.

In accordance with the invention, the surface property between the photoconductors used in a color image forming apparatus of the tandem system can be made uniform, and it is possible to realize an image forming apparatus having the plural photoconductors having small dispersions of roughness, lightness, reflectivity, etc., and the process cartridge used in this image forming apparatus. Accordingly, in the process cartridge and the image forming apparatus of the invention, no obstacle relating to the image, such as image deletion, etc. is caused and a preferable image can be obtained.

### BRIEF DESCRIPTION OF THE DRAWINGS

FIG. 1 is a schematic constructional view showing one embodiment of an image forming apparatus of a tandem system.

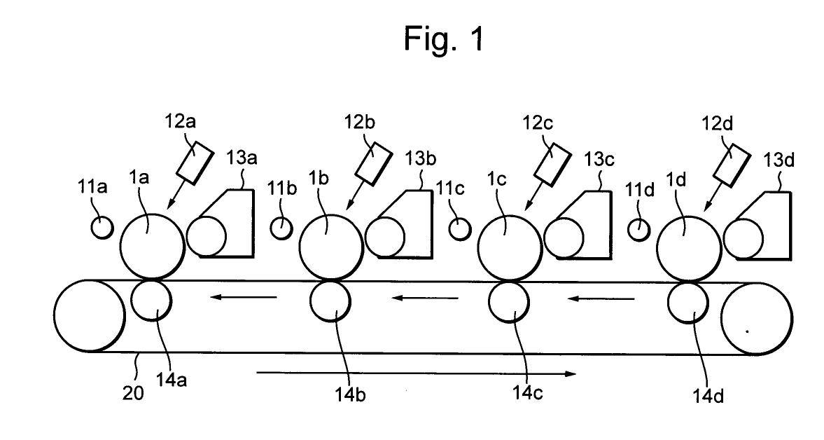

FIG. 2 is a schematic perspective view of sandblast processing of a photoconductor.

### DESCRIPTION OF THE PREFERRED EMBODIMENTS

Preferred embodiments of the invention will next be explained in detail. As noted above, the invention relates to the image forming apparatus of a tandem system having plural photoconductors and plural image forming means for respectively forming toner images of plural colors on the surfaces of the photoconductors. An important aspect of the invention is that for manufacturing the apparatus of the invention sandblast processing is performed on the surfaces of electrically conductive substrates of the photoconductors.

As mentioned above, sandblast processing is a conventionally known technique, and publicly known for use in surface processing the electrically conductive substrate of a photoconductor. However, according to the invention, the sandblast processing is particularly applied to the photoconductor in the image forming apparatus of the tandem system. In such a system, the image produced by the system is greatly influenced by dispersion of a surface property among the plural photoconductors. Thus, the surface property is made uniform among the photoconductors, and an obstacle to a good image, such as image deletion, can be effectively prevented. Accordingly, the invention also includes a process cartridge for the image forming apparatus of the tandem system, the cartridge having at least the photoconductor with respect to which the sandblast processing is performed, and the image forming means for forming the toner image on the surface of the photoconductor.

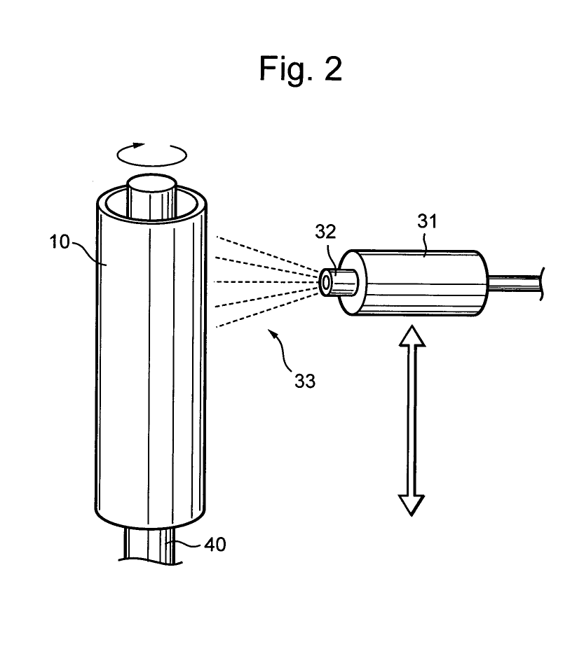

The sandblast processing according to the invention is primarily dry type blast processing. As shown in FIG. 2, the sandblast processing can be performed while an electrically conductive substrate 10 of the photoconductor is fixed by a rotating support tool 40, and the electrically conductive substrate 10 is rotated at a predetermined rate (about 50 to 200 rpm) in the direction of an arrow with a cylindrical shaft as a center. An injection nozzle 31 has an injection port 32 movable in parallel with the axis of the fixed electrically conductive substrate 10, and also has an unillustrated abrasive material supply port and an unillustrated compressed air supply port. The injection nozzle 31 is arranged at a predetermined distance (about 4 to 20 cm) from the outside surface of the electrically conductive substrate 10. During the processing, while an abrasive material and the compressed air are respectively supplied from the abrasive material supply port and the compressed air supply port into the injection nozzle 31, and the injection port 32 is moved at a predetermined speed (about 18 to 120 cm/minute), the abrasive material 33 is sprayed on the outside surface of the electrically conductive substrate 10 at a predetermined air pressure (about 98 to 490 kPa).

A 500 or more grade abrasive material, preferably about 11.5 to 14.5 μm in particle diameter, is suitable as the abrasive material 33 used in the sandblast processing. For example, MORUNDUM™ (Alumina; made by SHOWA DENKO K.K.) having a grade of about 1500 can be used. However, when the grade of the abrasive material is too coarse, the maximum value of surface roughness on the surface after the processing is too large, so that it is difficult to form a smooth film. Further, the coarse abrasive material sticks to the surface of the electrically conductive substrate 10. Therefore, a convex film-forming defect is caused and becomes a factor in the creation of a black-and-white spot defect of an image. Alumina, CARBORUNDUM, glass, synthetic resin, etc. can be used as the abrasive material. In particular, it is preferable to use alumina when the electrically conductive substrate 10 is constructed of an aluminum tube.

A material normally used for an electrically conductive substrate can be suitably selected and used as the electrically conductive substrate 10, but a tube manufactured from aluminum is most commonly used. It is preferable to use an aluminum tube where cutting processing already has been performed, as the electrically conductive substrate 10, in consideration of the need to prevent dispersion of the local surface property in the substrate and to secure desired external appearance characteristics and image characteristics. When the ratio of the inside diameter of the material to its wall thickness exceeds 75 in the case of the aluminum tube, there is a concern that the electrically conductive substrate 10 may be deformed by the pressure of the spray of the abrasive material. Therefore, this ratio is normally set to 75 or less. The surface roughness of the electrically conductive substrate 10 can be set to an arithmetic average roughness Ra of 0.26 to 0.35 μm, particularly, about 0.28 to 0.30 μm, by the sandblast processing according to the invention.

In the invention, only the sandblast processing on the surface of the electrically conductive substrate of the photoconductor is important for obtaining the above effects of the invention. Accordingly, the constructions of other portions of the image forming apparatus of the invention or the process cartridge and the layer construction, the material and construction of the photosensitive layer of the photoconductor, etc. are not particularly limited, but normally used layer construction and material are suitable. In particular, the effects of the invention are notable when the invention is applied to the image forming apparatus of high definition, having 1200 dpi or more in resolution, particularly, 2400 dpi or more.

The invention next will be explained in detail on the basis of concrete embodiments. However, the invention is not limited to the embodiments explained below.

### FIRST EMBODIMENT

A tube manufactured from aluminum, which has been treated to smooth the surface, for example by a turning machine, and having a thickness of 0.75 mm, and an outside diameter of 30 mm as the electrically conductive substrate 10, is cut to a length of 260.5 mm. Thereafter, the tube is degreased by a water type weak alkali cleaning liquid (pH=8) and cleaning processing is performed. The sandblast processing then is performed on the outer surface of the tube by using a dry type blast device (see FIG. 2). Concretely, the injection nozzle 31 is moved in the axial direction at a speed of 20 cm/minute while being held 5 cm from the outside surface of the electrically conductive substrate 10, which is rotated at 120 rpm. An 4000 grade alumina abrasive material as the abrasive material 33 is sprayed on the outside surface of the electrically conductive substrate 10 with an air pressure of 400 kPa. Thus, the sandblast processing is performed over the entire outside surface of the electrically conductive substrate 10.

An undercoat layer, 3 μm in film thickness, a photosensitive layer formed of a charge generation layer, 0.3 μm in film thickness, and a charge transport layer, 23 μm in film thickness, are sequentially formed on the outside surface of the electrically conductive substrate 10 after processing by a dip coating method, in order to manufacture a photoconductor. Similarly, one hundred photoconductors in total are obtained by performing the sandblast processing and the layer formation.

The thus obtained one hundred photoconductors are divided into 25 sets of four photoconductors, and are attached to a color laser beam printer with a resolution of 1200 dpi. To evaluate quality, initial printing is then performed and the patterns of four gradations in the four colors are printed. In such an evaluation, the surface roughness of each of the one hundred electrically conductive substrates 10 was evaluated after the sandblast processing by using SURFCOM 1400D manufactured by Tokyo Seimitsu Co., Ltd. as a measuring device at a reference length of 2.5 mm in accordance with JIS B0601 (year 2001). In this evaluation, the arithmetic average roughness Ra ranged from 0.28 to 0.30 μm, and a lightness ranged from 59 to 61% according to the Commission Internationale d'Eclairage (CIE) standard.

### Comparative Example 1

Similarly to the evaluation of the first embodiment, one hundred photoconductors were manufactured except that no sandblast processing was performed on the surface of the electrically conductive substrate 10. These photoconductors were attached to the color laser beam printer used in the first embodiment, and patterns similar to those of the first embodiment were printed. Similarly to the evaluation of the first embodiment, the surface roughnesses of these one hundred electrically conductive substrates 10 on which the sandblast processing of the invention was not performed were evaluated. In this evaluation, the arithmetic average roughness Ra ranged from 0.18 to 0.23 μm, and lightness ranged from 87 to 93% according to the Commission Internationale d'Eclairage (CIE) standard.

### SECOND EMBODIMENT

Similarly to the first embodiment, one hundred photoconductors were manufactured on the surfaces of one hundred electrically conductive substrates 10 that had been treated to smooth their outer surfaces, for example by a turning machine over a number of days by performing the sandblast processing and the layer formation. These one hundred photoconductors were divided into 25 sets of four photoconductors, and attached to the color laser beam printer of 1200 dpi resolution. Initial printing was performed and the patterns of four gradations in the four colors were printed. Similarly to the evaluation of the first embodiment, the surface roughness of each of the one hundred electrically conductive substrates 10 after the sandblast processing was evaluated. In this evaluation, the arithmetic average roughness Ra ranged from 0.28 to 0.30 μm, and lightness ranged from 59 to 61% according to the Commission Internationale d'Eclairage (CIE) standard.

### Comparative Example 2

Similarly to the evaluation of the second embodiment, one hundred photoconductors were manufactured on the surfaces of one hundred electrically conductive substrates 10 performed with respect to the cutting processing over the same period as in the case of the second embodiment described above, except that no sandblast processing was performed. These one hundred photoconductors were attached to the color laser beam printer used in the second embodiment and patterns similar to those of the second embodiment are printed. Similarly to the first embodiment, the surface roughnesses of these one hundred electrically conductive substrates 10 on which sandblast processing was not performed, were evaluated. In the evaluation, the arithmetic average roughness Ra ranged from 0.18 to 0.23 μm, and lightness ranged from 87 to 93% according to the Commission Internationale d'Eclairage (CIE) standard.

A density measurement (image evaluation) was made with respect to the printed patterns of the respective twenty-five sets obtained with the photoconductors of the above embodiments and comparative examples. When image deletion occurred, even in one photoconductor within a set, “image deletion” is noted. When no image deletion occurred in the images of all the four photoconductors of a set, the set was evaluated as “preferable”. These results are shown within the following Table 1.

TABLE 1

| First | | Comparative | | Second | | Comparative | |
|---|---|---|---|---|---|---|---|
| embodiment | | example 1 | | embodiment | | example 2 | |
| Set | image | Set | image | Set | image | Set | image |
| No. | evaluation | No. | evaluation | No. | evaluation | No. | evaluation |
| 1 | preferable | 1 | preferable | 1 | preferable | 1 | preferable |
| 2 | preferable | 2 | image | 2 | preferable | 2 | image |
| | | | deletion | | | | deletion |
| 3 | preferable | 3 | preferable | 3 | preferable | 3 | preferable |
| 4 | preferable | 4 | preferable | 4 | preferable | 4 | preferable |
| 5 | preferable | 5 | preferable | 5 | preferable | 5 | preferable |
| 6 | preferable | 6 | preferable | 6 | preferable | 6 | preferable |
| 7 | preferable | 7 | preferable | 7 | preferable | 7 | preferable |
| 8 | preferable | 8 | image | 8 | preferable | 8 | image |
| | | | deletion | | | | deletion |
| 9 | preferable | 9 | preferable | 9 | preferable | 9 | preferable |
| 10 | preferable | 10 | preferable | 10 | preferable | 10 | preferable |
| 11 | preferable | 11 | preferable | 11 | preferable | 11 | preferable |
| 12 | preferable | 12 | preferable | 12 | preferable | 12 | image |
| | | | | | | | deletion |
| 13 | preferable | 13 | preferable | 13 | preferable | 13 | preferable |
| 14 | preferable | 14 | preferable | 14 | preferable | 14 | preferable |
| 15 | preferable | 15 | preferable | 15 | preferable | 15 | preferable |
| 16 | preferable | 16 | image | 16 | preferable | 16 | image |
| | | | deletion | | | | deletion |
| 17 | preferable | 17 | preferable | 17 | preferable | 17 | preferable |
| 18 | preferable | 18 | preferable | 18 | preferable | 18 | preferable |
| 19 | preferable | 19 | preferable | 19 | preferable | 19 | preferable |
| 20 | preferable | 20 | preferable | 20 | preferable | 20 | preferable |
| 21 | preferable | 21 | preferable | 21 | preferable | 21 | image |
| | | | | | | | deletion |
| 22 | preferable | 22 | preferable | 22 | preferable | 22 | preferable |
| 23 | preferable | 23 | preferable | 23 | preferable | 23 | preferable |
| 24 | preferable | 24 | image | 24 | preferable | 24 | image |
| | | | deletion | | | | deletion |
| 25 | preferable | 25 | image | 25 | preferable | 25 | image |
| | | | deletion | | | | deletion |

The entire disclosure of applicant's corresponding Japanese patent application, No. JP 2003 350277, filed Oct. 9, 2003, is incorporated herein by reference.

1. A process cartridge for an image forming apparatus of a tandem system, comprising
a photoconductor having at least a photosensitive layer on an electrically conductive substrate having a sandblast-processed surface; and
image forming means for forming a toner image on an outer surface of the photoconductor.

2. The process cartridge according to claim 1, wherein the process cartridge is used at 1200 dpi or more in resolution.

3. An image forming apparatus of a tandem system comprising
plural photoconductors having at least a photosensitive layer on an electrically conductive substrate having a sandblast-processed outer surface, and
plural image forming means for respectively forming toner images of plural colors on the surfaces of the photoconductors.

4. The image forming apparatus according to claim 3, wherein the image forming apparatus is used at 1200 dpi or more in resolution.

5. An image forming apparatus of a tandem system comprising
photoconductors, each having at least a photosensitive layer on an electrically conductive substrate, for the respective four colors cyan, magenta, yellow and black, the substrate of each photoconductor having a sandblast-processed outer surface; and
image forming means of the four colors for respectively forming toner images on outer surfaces of the photoconductors.

6. The image forming apparatus according to claim 5, wherein the image forming apparatus is used at 1200 dpi or more in resolution.

7. A method of manufacturing a process cartridge for an image forming apparatus of a tandem system, comprising the steps of:
providing a photoconductor having at least a photosensitive layer and an electrically conductive substrate, including
providing the electrically conductive substrate,
sandblast-processing a surface of the substrate, and
providing at least the photosensitive layer on the sandblast-processed substrate surface; and
providing a means for forming a toner image on the photosensitive layer.
